(19) United States
(12) Patent Application Publication
(10) Pub. No.: US 2015/0274973 A1
(43) Pub. Date: Oct. 1, 2015

(54) PREPARING METHOD OF TRANSPARENT CURED SILOXANE MATERIAL BY HYDROLYSIS-CONDENSATION REACTION

(71) Applicant: KOREA ADVANCED INSTITUTE OF SCIENCE AND TECHNOLOGY, Daejeon (KR)

(72) Inventors: Byeong-Soo Bae, Daejeon (KR); Junyoung Bae, Daejeon (KR); Yubae KIM, Daejeon (KR)

(21) Appl. No.: 14/665,098

(22) Filed: Mar. 23, 2015

(30) Foreign Application Priority Data
Apr. 1, 2014 (KR) 10-2014-0038858

(51) Int. Cl. C08L 83/06; C08L 43/04

(52) U.S. Cl. CPC C08L 83/06; C08L 43/04; C08L 2201/02; C08L 2201/08; C08L 2201/10; C08L 2203/206

(57) ABSTRACT

The present application relates to a transparent cured siloxane material having high transparency and refractive index, long-term heat resistance and ultraviolet resistance, and excellent hardness, and a preparing method using the same. The transparent cured siloxane material is prepared by using an oligosiloxane resin having a vinyl-silicon bond through a hydrolysis-condensation reaction, an oligosiloxane resin having a hydrogen-silicon bond through a hydrolysis-condensation reaction, and a metal catalyst for hydrosilylation. The present application also relates to a light emitting diode encapsulating material including the transparent cured siloxane material and a light emitting diode capsulated by using the light emitting diode encapsulating material.

### CROSS-REFERENCE TO RELATED APPLICATION

This application claims the benefit under 35 USC 119(a) of Korean Patent Application No. 10-2014-0038858 filed on Apr. 1, 2014, in the Korean Intellectual Property Office, the entire disclosure of which is incorporated herein by reference for all purposes.

### TECHNICAL FIELD

The embodiments described herein pertain generally to a transparent cured siloxane material including an oligosiloxane resin containing a vinyl-silicon bond, which is prepared by a hydrolysis-condensation reaction, an oligosiloxane resin containing a hydrogen-silicon bond, which is prepared by a hydrolysis-condensation reaction, and a metal catalyst for hydrosilylation, and a preparing method of the cured material of siloxane, a light emitting diode (LED) encapsulating material including the transparent cured siloxane material, and a LED capsulated by using the encapsulating material.

### BACKGROUND

A silicon resin has been widely used as a transparent encapsulating resin due to its high transparency, thermal stability and hardness. Since a silicon molecule having a hydrogen-silicon bond and a silicon molecule having a vinyl-silicon bond can be cured through a hydrosilylation reaction, they have been generally used for a transparent cured siloxane material like a LED encapsulating material. When a resin encapsulating a LED chip is exposed to heat or light generated from the chip, bonds existing within an organic polymer are broken, thereby declining the optical characteristic of the resin. Such phenomenon is a yellowing phenomenon. Since the yellowing phenomenon reduces lifetime of a device, there are increasing researches on a silicon resin having superior heat resistance and light resistance.

Korean Patent Application Publication Nos. 10-2004-0047716, 10-2007-0032320, and others disclose the above-described silicon resins, which are characterized in that the silicon resins are a cured material including a polysiloxane where a vinyl group is bonded to a silicon atom, a hydrogen polysiloxane where a hydrogen atom is bonded to a silicon atom, and a hydrosilylation catalyst. As a result of an advantage of an addition polymerization, the cured material has an advantage in that it less causes shrinkage and a by-product, is highly transparent, and has superior heat resistance.

Accordingly, example embodiments of the present disclosure provide a cured material, which has a high refractive index and excellent transparency and is less discolored as time lapses in a high-temperature or ultraviolet environment, by synthesizing the above-described siloxane resin through a hydrolysis. Since a siloxane compound having an organic functional group can be cured by heat or light, organic silicon compounds having various structures can be prepared. Since the organic silicon compound has a Si—O—Si bond, it has superior thermal and mechanical stability, and it is possible to prepare an inorganic-organic hybrid material where a siloxane is formed on a polymer phase by uniformly bonding an organic functional group to such inorganic network structure in a molecular scale followed by polymerizing the organic group. The hybrid material forms a linear, combic, dendrite, or branch shape and so on according to the structure of the organic siloxane compound, and it is possible to prepare a material having optical and electrical properties such as a high refractive index and high hardness by securing various physical properties through crosslink of different molecules. Especially, since the siloxane resin can uniformly include a metal alkoxide through hydrolysis-condensation reaction, it is useful as a material having a high refractive index and being highly transparent, and thus, suitable for applications to optical devices such as a LED encapsulating material.

For these applications, researchers have studied a method for preparing organic oligosiloxane by using a hydrolysis-condensation reaction. Korean Patent No. 10-0614976 discloses a method for preparing a hybrid cured material having an epoxy- and acryl-based organic functional group through a non-hydrolytic sol-gel reaction. The siloxane resin by the non-hydrolytic condensation of organic silane containing a hydroxyl group has a disadvantage in that a degree of condensation is low, and it is difficult to uniformly bond the metal alkoxide due to its difference in reactivity. Accordingly, the degree of condensation can be improved, and a yield rate can be increased by synthesizing an organic oligosiloxane through a hydrolysis-condensation reaction with adding water. As a result, a silanol group remaining within the siloxane resin is minimized so as to improve the stability and performance.

J. V. Crivello, et. al. disclose a method for producing an organic oligosiloxane resin through the hydrolysis-condensation reaction of an organic alkoxysilane in U.S. Pat. No. 6,069,259 and the chemical material article (Chemistry of Materials, vol. 9, pp. 1554-1561, 1997). However, since they did not suggest a producing method to additionally include a metal alkoxide, there is a disadvantage in that an organic oligosiloxane resin cannot be applied to a cured material of siloxane having a high refractive index.

### SUMMARY

In view of the foregoing problems, the present disclosure provides a transparent cured siloxane material having high transparency and refractive index, long-term heat resistance and ultraviolet resistance, and excellent hardness, and a preparing method using the same. The transparent cured siloxane material is prepared by using an oligosiloxane resin having a vinyl-silicon bond through a hydrolysis-condensation reaction, an oligosiloxane resin having a hydrogen-silicon bond through a hydrolysis-condensation reaction, and a metal catalyst for hydrosilylation. The present disclosure also provides a light emitting diode encapsulating material including the transparent cured siloxane material and a light emitting diode capsulated by using the light emitting diode encapsulating material.

However, the problems sought to be solved by the present disclosure are not limited to the above description and other problems can be clearly understood by those skilled in the art from the following description.

In accordance with a first aspect of the present disclosure, there is provided a preparing method of a transparent cured siloxane material, including: (a) performing a hydrolysis-condensation reaction of a reactant including an alkoxysilane selected from the group consisting of the following Chemical Formulas 1, 2, 3, and combinations thereof to prepare an oligosiloxane resin having a vinyl-silicon bond:

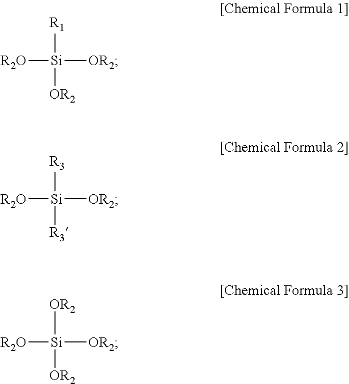

wherein the formulas,

each of R₁, R₃, and R₃′ is independently a vinyl group, methyl group or phenyl group, and

R₂ is a linear or branched C₁ to C₇ alkyl group,

provided that the alkoxysilane included in the reactant has at least one vinyl-silicon bond and that the case where the reactant including the alkoxysilane includes only the alkoxysilane of Chemical Formula 3 is excluded;

(b) performing a hydrolysis-condensation reaction of a reactant including an alkoxysilane selected from the group consisting of the following Chemical Formulas 4, 5, 6, and combinations thereof to prepare an oligosiloxane resin having a hydrogen-silicon bond:

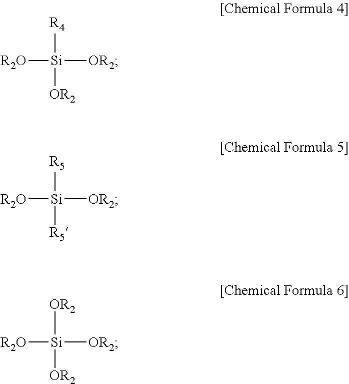

wherein the formulas,

each of R₄, R₅, and R₅′ is independently hydrogen, methyl group or phenyl group, and

R₂ is a linear or branched C₁ to C, alkyl group;

provided that the alkoxysilane included in the reactant has at least one hydrogen-silicon bond and that the case where the reactant including the alkoxysilane includes only the alkoxysilane of Chemical Formula 6 is excluded; and

(c) adding a metal catalyst for hydrosilylation to a mixture including the prepared oligosiloxane resin having the vinyl-silicon bond and the prepared oligosiloxane resin having the hydrogen-silicon bond to cure the mixture.

In accordance with a second aspect of the present disclosure, there is provided a transparent cured siloxane material, including: about 10 parts by weight to about 90 parts by weight of an oligosiloxane resin having a vinyl-silicon bond, which is prepared by performing a hydrolysis-condensation reaction of a reactant including an alkoxysilane selected from the group consisting of the following Chemical Formulas 1, 2, 3, and combinations thereof:

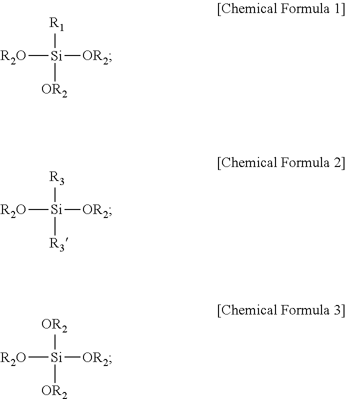

wherein the formulas,

each of R₁, R₃, and R₃′ is independently a vinyl group, methyl group or phenyl group, and

R₂ is a linear or branched C₁ to C, alkyl group,

provided that the alkoxysilane included in the reactant has at least one vinyl-silicon bond and that the case where the reactant including the alkoxysilane includes only the alkoxysilane of Chemical Formula 3 is excluded;

about 9 parts by weight to about 90 parts by weight of an oligosiloxane resin having a hydrogen-silicon bond, which is prepared by performing a hydrolysis-condensation reaction of a reactant including an alkoxysilane selected from the group consisting of the following Chemical Formulas 4, 5, 6, and combinations thereof:

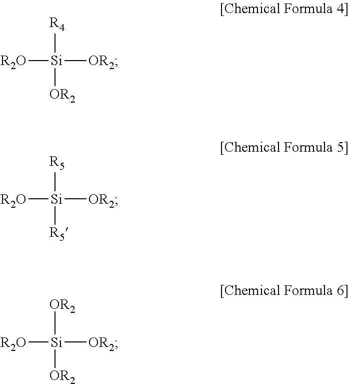

wherein the formulas,

each of R₄, R₅, and R₅′ is independently hydrogen, methyl group or phenyl group, and

R₂ is a linear or branched C₁ to C, alkyl group,

provided that the alkoxysilane included in the reactant has at least one hydrogen-silicon bond and that the case where the reactant including the alkoxysilane includes only the alkoxysilane of Chemical Formula 6 is excluded; and

about 0.01 parts by weight to about 1 parts by weight of a metal catalyst for hydrosilylation.

In accordance with a third aspect of the present disclosure, there is provided a light emitting diode (LED) encapsulating material, including the transparent cured siloxane material.

In accordance with a fourth aspect of the present disclosure, there is provided a light emitting diode (LED) capsulated by using encapsulating material including a transparent cured siloxane material.

The transparent cured siloxane material in accordance with an example embodiment of the present disclosure can provide high transparency, a high refractive index, long-term heat resistance, long-term ultraviolet resistance, and excellent hardness.

In accordance with an example embodiment of the present disclosure, the organic oligosiloxane resins including a vinyl-silicon bond and a hydrogen-silicon bond, which are prepared through the hydrolysis-condensation reaction between the alkoxysilane and metal alkoxide, may have a linear- or branched-chain structure with an increased degree of condensation.

In accordance with an example embodiment of the present disclosure, if a metal alkoxide is added, there may be a catalytic effect in promoting curing in preparing the transparent cured siloxane material, and a curing temperature may be lowered with increasing an amount of the metal alkoxide to be added.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a ²⁹Si nuclear magnetic resonance (NMR) spectrum of an organic oligosiloxane resin in accordance with an example of the present disclosure.

FIG. 2 is a matrix assisted laser desorption Ionization-time of flight (MALDI-TOF) spectrum of an organic oligosiloxane resin in accordance with an example of the present disclosure.

FIG. 3 is a differential scanning calorimetry (DSC) graph according to an amount of a metal alkoxide to be added in an example of the present disclosure.

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments, but can be realized in various other ways. In the drawings, certain parts not directly relevant to the description are omitted to enhance the clarity of the drawings, and like reference numerals denote like parts throughout the whole document.

Throughout the whole document of the present disclosure, the terms “connected to” or “coupled to” are used to designate a connection or coupling of one element to another element and include both a case where an element is “directly connected or coupled to” another element and a case where an element is “electronically connected or coupled to” another element via still another element.

Throughout the whole document of the present disclosure, the term of “on” that is used to designate a position of one element with respect to another element includes both a case that the one element is adjacent to the another element and a case that any other element exists between these two elements.

Throughout the whole document of the present disclosure, the terms of “comprises or includes” and/or “comprising or including” means that one or more other components, steps, operations, and/or the existence or addition of elements are not excluded in addition to the described components, steps, operations and/or elements.

Throughout the whole document of the present disclosure, the terms of “about or approximately” or “substantially” are intended to have meanings close to numerical values or ranges specified with an allowable error and intended to prevent accurate or absolute numerical values disclosed for understanding of the present invention from being illegally or unfairly used by any unconscionable third party.

Throughout the whole document of the present disclosure, the term of “step of” does not mean “step for.”

Throughout the whole document of the present disclosure, the term of “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Throughout the whole document of the present disclosure, the description of “A and/or B” means “A or B, or A and B.”

Throughout the whole document of the present disclosure, the term an “alkyl” may include a linear or branched, saturated or unsaturated C₁₋₇ or C₁₋₂₀ alkyl, and for example, may includemethyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosanyl, or possible isomers thereof, but not be limited to, but may not be limited thereto.

Hereinafter, example embodiments of the present disclosure are described in detail, but the present disclosure may not be limited thereto.

In accordance with a first aspect of the present disclosure, there is provided a preparing method of a transparent cured siloxane material, including: (a) being reacted by hydrolysis-condensation reaction of a reactant including an alkoxysilane selected from the group consisting of the following Chemical Formulas 1, 2, 3, and combinations thereof to prepare an oligosiloxane resin having a vinyl-silicon bond:

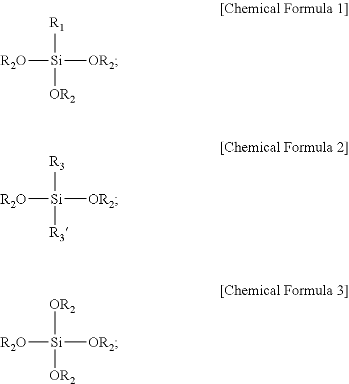

wherein the formulas,

each of R₁, R₃, and R₃′ is independently a vinyl group, a methyl group or a phenyl group, and

R₂ is a linear or branched C₁ to C₇ alkyl group,

provided that the alkoxysilane included in the reactant has at least one vinyl-silicon bond and that the case where the reactant including the alkoxysilane includes only the alkoxysilane of Chemical Formula 3 is excluded;

(b) being reacted by hydrolysis-condensation reaction of a reactant including an alkoxysilane selected from the group consisting of the following Chemical Formulas 4, 5, 6, and combinations thereof to prepare an oligosiloxane resin having a hydrogen-silicon bond:

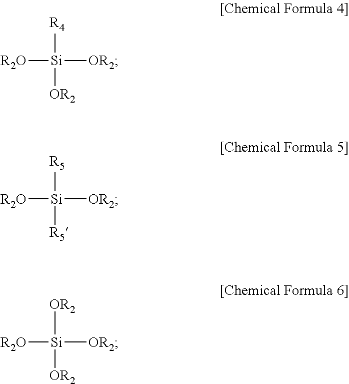

wherein the formulas,

each of R₄, R₅, and R₅′ is independently hydrogen, a methyl group or a phenyl group, and

R₂ is a linear or branched C₁ to C, alkyl group,

provided that the alkoxysilane included in the reactant has at least one hydrogen-silicon bond and that the case where the reactant including the alkoxysilane includes only the alkoxysilane of Chemical Formula 6 is excluded; and

(c) adding a metal catalyst for hydrosilylation to a mixture including the prepared oligosiloxane resin having the vinyl-silicon bond and the prepared oligosiloxane resin having the hydrogen-silicon bond to cure the mixture.

In accordance with an example embodiment of the present disclosure, R₂ in the Chemical Formulas 1 to 6 may be identical to or different from one another.

In accordance with an example embodiment of the present disclosure, the reactant including the alkoxysilane may include combinations of the alkoxysilane of Chemical Formula 1, the alkoxysilane of Chemical Formula 2, the alkoxysilane of Chemical Formulas 1 and 2, the alkoxysilane of Chemical Formulas 1 and 3, the alkoxysilane of Chemical Formulas 2 and 3, the alkoxysilane of Chemical Formulas 1, 2 and 3, the alkoxysilane of Chemical Formula 4, the alkoxysilane of Chemical Formula 5, the alkoxysilane of Chemical Formulas 4 and 5, the alkoxysilane of Chemical Formulas 4 and 6, the alkoxysilane of Chemical Formulas 5 and 6, or the alkoxysilane of Chemical Formulas 4, 5 and 6, but may not be limited thereto.

In accordance with an example embodiment of the present disclosure, the alkoxysilane may include a member selected from the group consisting of vinyltrimethoxysilane, vinyltriethoxysilane, vinyltripropoxysilane, methylvinyldimethoxysilane, methylvinyldiethoxysilane, methylvinyldipropoxysilane, dimethyldimethoxysilane, dimethyldiethoxysilane, diphenyldimethoxysilane, diphenyldiethoxysilane, methyldimethoxysilane, methyldiethoxysilane, methyltrimethoxysilane, methyltriethoxysilane, tetramethylorthosilicate, tetraethylorthosilicate and combinations thereof, but may not be limited thereto.

In accordance with an example embodiment of the present disclosure, the hydrolysis-condensation reaction of the reactant including the alkoxysilane may be performed in the presence an acidic or basic catalyst, but may not be limited thereto.

In accordance with an example embodiment of the present disclosure, the condensation includes a hydrolysis using water, which is different from a non-hydrolytic sol-gel reaction. The condensation does not require a high-temperature heat treatment process, and can achieve a high degree of condensation and solve the problem of decrease in stability by unreacted hydroxyl groups existing in the resin. For example, the condensation reaction may be performed at a temperature of from about 0° C. to about 100° C., from about 10° C. to about 100° C., from about 20° C. to about 100° C., from about 30° C. to about 100° C., from about 40° C. to about 100° C., from about 50° C. to about 100° C., from about 0° C. to about 90° C., from about 0° C. to about 80° C., from about 40° C. to about 80° C., from about 50° C. to about 80° C., or from about 60° C. to about 80° C., but may not be limited thereto.

In accordance with an example embodiment of the present disclosure, the oligosiloxane resin may be subject to a process, in which the alkoxysilane reactants are mixed with each other at an equivalent ratio of from about 0.001 to about 1 in the presence of an acidic or basic catalyst, and the alkoxysilane mixture is then subject to the condensation reaction, but the present disclosure may not be limited thereto.

In accordance with an example embodiment of the present disclosure, an amount of the acidic or basic catalyst may be from about 0.0001 mol to about 1 mol with respect to about 1 mol of the alkoxysilane, but not be limited thereto. The amount of the acidic or basic catalyst may be from about 0.1 g to about 1 g with respect to about 1 mol of the silane mixture, but may not be limited thereto.

In accordance with an example embodiment of the present disclosure, as the acidic catalyst, any acidic catalyst known for the hydrolysis-condensation reaction in the art of the present disclosure may be used without limitation. For example, the acidic catalyst may include a member selected from the group consisting of an acidic ion exchange resin, hydrochloric acid, sulfuric acid, nitric acid, phosphoric acid, chlorosulfonic acid, iodic acid, tartaric acid, perchloric acid, a polyphosphoric acid, pyrophosphoric acid, para-toluic acid, trichloroacetic acid, formic acid, acetic acid, citric acid, and combinations thereof, but may not be limited thereto.

In accordance with an example embodiment of the present disclosure, as the basic catalyst, any basic catalyst known for the hydrolysis-condensation reaction in the art of the present disclosure may be used without limitation. For example, the basic catalyst may include a member selected from the group consisting of sodium hydroxide, potassium hydroxide, ammonia, n-butylamine, di-n-butylamine, tri-n-butylamine, imidazole, ammonium perchlorate, barium hydroxide, and combinations thereof, but may not be limited thereto.

In accordance with an example embodiment of the present disclosure, a metal alkoxide may be further added to each of the reactants including the alkoxysilane in the steps (a) and/or (b), but the present disclosure may not be limited thereto. For example, the metal alkoxide may include a member selected from the group consisting of zirconiumpropoxide, zirconiumethoxide, zirconiumbutoxide, titaniumpropoxide, titaniumethoxide, germaniumethoxide, aluminumethoxide, aluminumtributoxide, aluminumpropoxide, tantalumethoxide, tintetrapropoxide, and combinations thereof, but may not be limited thereto.

In accordance with an example embodiment of the present disclosure, the metal alkoxide may act as a catalyst to promote curing in the step (c), but may not be limited thereto. For example, if the metal alkoxide is added, the curing temperature may be lowered, the curing reactivity may be improved, and a curing start temperature may be lowered with increasing of the amount of the metal alkoxide to be added. However, the present disclosure may not be limited thereto.

In accordance with an example embodiment of the present disclosure, if the equivalent ratio of the alkoxysilane and the metal alkoxide is less than about 0.001, synthesis of the silane mixture is possible, but the mixture is not suitable for application to an optical material due to an insignificant effect in increase of a refractive index, and if the equivalent ratio is more than about 1, theoretically a phase separation resulting from difference in reactivity may occur.

In accordance with an example embodiment of the present disclosure, since the metal alkoxide has a faster reaction rate compared with the alkoxysilane in the step (c), it is necessary to adjust the reaction rate to prepare a more homogeneous resin composition.

In accordance with an example embodiment of the present disclosure, a high refractive index can be obtained by providing a siloxane uniformly containing a silicon-metal heterometallic bond through the hydrolysis-condensation reaction. Especially, since the siloxane, in which the heterometallic bond exists, can be thermally cured even in the presence of a small amount of a metal catalyst due to its catalytic effect for promoting the hydrosilylation, the problem of the reduction in the heat resistance resulting from a residual catalyst can be resolved.

In general, a refractive index of a siloxane material varies depending on a form of an organic group bonded to a silicon atom. For example, a phenyl group bonded to the siloxane has a higher refractive index than that of a methyl group. Accordingly, it is preferable to conform the refractive index to the refractive index of an external layer by adjusting the ratio of the organic group (e.g., phenyl group) of the composition of the example embodiments of the present disclosure.

In accordance with an example embodiment of the present disclosure, as confirmed from the following Reaction Scheme 1, an inorganic siloxane network structure is formed through an alkoxy group condensation reaction of the alkoxysilane as a starting material, with forming an oligosiloxane modified by an organic functional group like R′ and/or R″. Especially, the condensation between the starting materials is promoted by proceeding with hydrolysis in the presence of a liquid phase catalyst, so that the degree of the condensation and a molecular weight can be increased. In addition, damage of the hydrogen-silicon group is prevented during the reaction process in the acid atmosphere, so that a cured siloxane composition, which can be hydrosilylated, can be prepared.

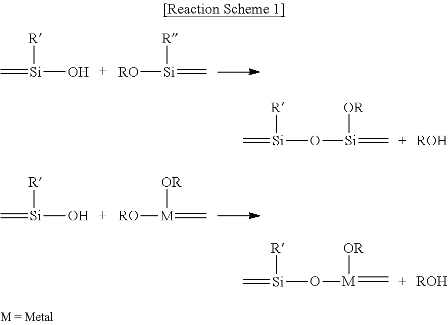

In the Reaction Scheme 1, each of R, R′ and R″ is an organic group including hydrogen or carbon atom.

In accordance with an example embodiment of the present disclosure, the metal catalyst may include a member selected from the group consisting of platinum, rhodium, iridium, palladium, ruthenium, and combinations thereof, but may not be limited thereto. For example, the metal catalyst may include a member selected from the group consisting of platinum(0)-1,3-divinyl-1,1,3,3-tetramethyldisiloxane, platinum-cyclovinylmethylsiloxane complex, tris(dibutylsulfide)rhodium trichloride, and combinations thereof, but may not be limited thereto. As to a mixture ratio of the metal catalyst, it is generally preferable to mix the metal catalyst in an amount of from about 1 ppm to about 200 ppm with respect to the weight of the organic oligosiloxane component.

In accordance with an example embodiment of the present disclosure, the curing in the step (c) may include a heat treatment performed at a temperature of about 100° C. or higher, but may not be limited thereto. For example, the temperature may be from about 100° C. to about 300° C., from about 100° C. to about 250° C., from about 100° C. to about 200° C., from about 100° C. to about 150° C., from about 150° C. to about 300° C., from about 150° C. to about 250° C., from about 150° C. to about 200° C., from about 200° C. to about 300° C., from about 200° C. to about 250° C., or from about 250° C. to about 300° C., but may not be limited thereto.

According to the preparing method of the transparent cured siloxane material cured material in the first aspect of the present disclosure, a transparent cured siloxane material having high transparency and refractive index, long-term heat resistance and ultraviolet resistance, and excellent hardness can be obtained.

In accordance with a second aspect of the present disclosure, there is provided a transparent cured siloxane material, including: an oligosiloxane resin having a vinyl-silicon bond from about 10 parts by weight to about 90 parts by weight, which is prepared by being reacted by hydrolysis-condensation reaction of a reactant including an alkoxysilane selected from the group consisting of the following Chemical Formulas 1, 2, 3, and combinations thereof:

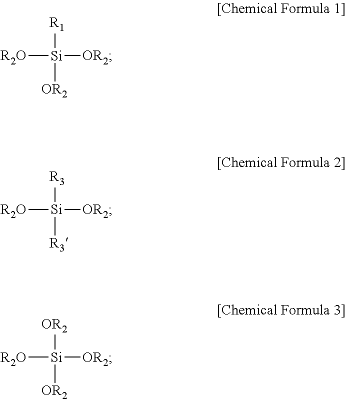

wherein the formulas,

each of R₁, R₃, and R₃′ is independently a vinyl group, a methyl group or a phenyl group, and

R₂ is a linear or branched C₁ to C, alkyl group,

provided that the alkoxysilane included in the reactant has at least one vinyl-silicon bond and that the case where the reactant including the alkoxysilane includes only the alkoxysilane of Chemical Formula 3 is excluded;

about 9 parts by weight to about 90 parts by weight of an oligosiloxane resin having a hydrogen-silicon bond, which is prepared by being reacted by hydrolysis-condensation reaction of a reactant including an alkoxysilane selected from the group consisting of the following Chemical Formulas 4, 5, 6, and combinations thereof:

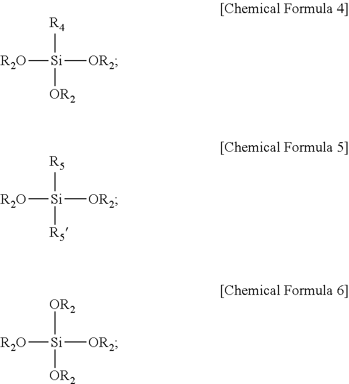

wherein the formulas,

each of R₄, R₅, and R₅′ is independently hydrogen, a methyl group or a phenyl group, and

R₂ is a linear or branched C₁ to C, alkyl group,

provided that the alkoxysilane included in the reactant has at least one hydrogen-silicon bond and that the case where the reactant including the alkoxysilane includes only the alkoxysilane of Chemical Formula 6 is excluded; and

about 0.01 parts by weight to about 1 part by weight of a metal catalyst for hydrosilylation.

In accordance with an example embodiment of the present disclosure, the transparent cured siloxane material may be used as a LED encapsulating material or an optical material, but may not be limited thereto.

In accordance with an example embodiment of the present disclosure, the transparent cured siloxane material may further include an additive selected from the group consisting of a solvent, a dye, a pigment, a flavoring, a surfactant, an antioxidant, a nano-particle of an oxide or nitride, an anti-flaming agent, a metal filler, an adhesion promoter, a corrosion inhibitor, a light stabilizer, a heat stabilizer, a dispersant, a sterilizer, a heat-resisting agent, and combinations thereof, but may not be limited thereto.

In accordance with accordance with a third aspect of the present disclosure, there is provided a LED encapsulating material including the transparent siloxane cured material according to the second aspect of the present disclosure.

In accordance with a fourth aspect of the example embodiment, a LED capsulated by using a encapsulating material including the transparent siloxane cured material according to the third aspect of the present disclosure.

All the descriptions of the third and fourth aspects of the example embodiments of the present disclosure can be applied to the first and second aspects of the example embodiments of the present disclosure.

Hereinafter, example embodiments of the present disclosure are described in more detail by using Examples, but the Examples are merely illustrative to facilitate understanding of the present disclosure, and the present disclosure may not be limited to the Examples.

### EXAMPLES

### Example 1

Methyldiethoxysilane (MDES, Gelest), dimethyldiethoxysilane (DMDES), and tetraethylorthosilicate were taken into and mixed in a 100 mL two-neck flask at a molar ratio of 1:1:0.1. Subsequently, water and a hydrochloric acid catalyst were added thereto at ratios of 1.5 mol and 0.0001 mol, respectively, with respect to 1 mol of the mixture and stirred at 60° C. through reflux for 48 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a hydrogen-silicon bond was finally obtained.

Vinyltriethoxysilane (VTES) and dimethyldiethoxysilane (DMDES) were taken into and mixed in a 100 mL two-neck flask at a molar ratio of 1:1.5. Subsequently, water and a hydrochloric acid catalyst were added thereto at ratios of 1.5 mol and 0.0001 mol, respectively, with respect to 1 mol of the mixture and stirred at 60° C. through reflux for 48 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a vinyl-silicon bond was finally obtained.

Based on the mixture of the oligosiloxane resin having the hydrogen-silicon bond and the oligosiloxane resin having the vinyl-silicon bond, a 20 ppm platinum catalyst was added to and mixed with 100 parts by weight of the oligosiloxane mixture. After the oligosiloxane resin mixture, to which the platinum catalyst was added, was sufficiently stirred, it was cured at 150° C. for 2 hours by carrying out defoaming.

### Example 2

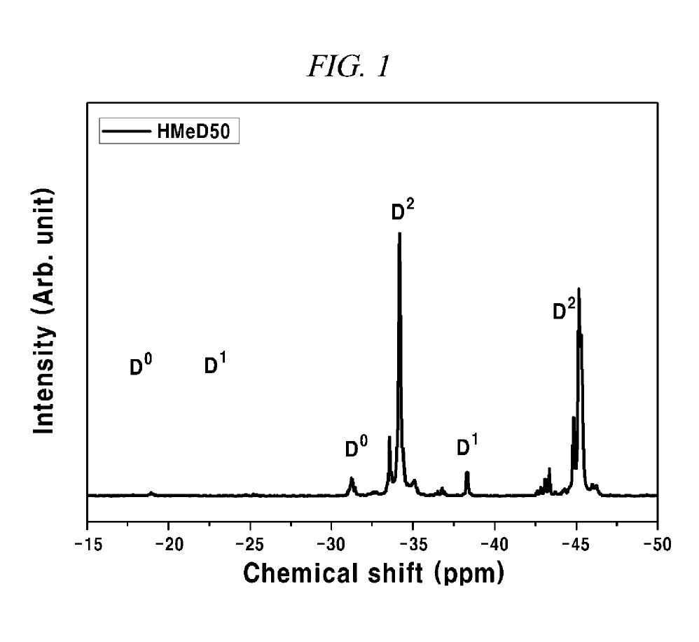

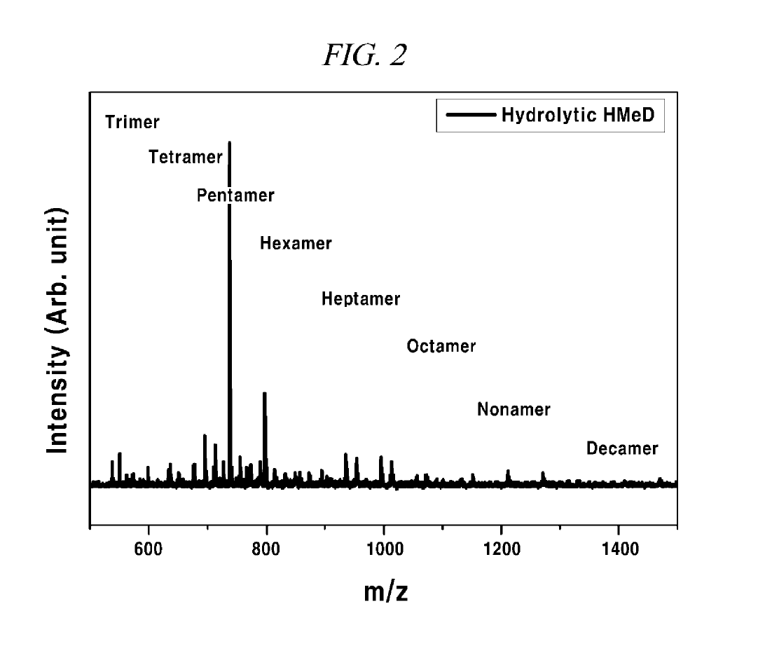

Methyldiethoxysilane (MDES, Gelest) and diphenyldiethoxysilane (DPDES, Alddrich) were taken into and mixed in a 100 mL two-neck flask at a molar ratio of 1:1. Subsequently, water and a hydrochloric acid catalyst were added thereto at ratios of 1 mol and 0.0001 mol, respectively, with respect to 1 mol of the mixture and stirred at 60° C. through reflux for 48 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a hydrogen-silicon bond was finally obtained. A degree of condensation of the obtained oligosiloxane having the hydrogen-silicon bond was calculated by using ²⁹Si nuclear magnetic resonance(NMR) (refer to FIG. 1), and distribution of a molecular weight was analyzed by using matrix assisted laser desorption Ionization-time of flight(MALDI-TOF) (refer to FIG. 2).

Methyldimethoxysilane (MVDMS, TCI) and diphenyldiethoxysilane (DPDES, Alddrich) were taken into and mixed in a 100 mL two-neck flask at a molar ratio of 1:1. Subsequently, water and a sodium hydroxide catalyst were added thereto at ratios of 1 mol and 0.0001 mol, respectively, with respect to 1 mol of the mixture and stirred at 60° C. through reflux for 48 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a vinyl-silicon bond was finally obtained.

Based on the mixture of the oligosiloxane resin having the hydrogen-silicon bond and the oligosiloxane resin having the vinyl-silicon bond, a 20 ppm platinum catalyst was added to 100 parts by weight of the oligosiloxane mixture. After the oligosiloxane resin mixture, to which the platinum catalyst was added, was sufficiently stirred, it was cured at 150° C. for 2 hours by carrying out defoaming.

### Example 3

Methyldiethoxysilane and dimethyldiethoxysilane were taken in to and mixed in a 100 mL two-neck flask at a molar ratio of 1:1. Subsequently, water and a hydrochloric acid catalyst were added thereto at ratios of 1.5 mol and 0.0001 mol, respectively, with respect to 1 mol of the mixture and stirred at 60° C. through reflux for 48 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a hydrogen-silicon bond was finally obtained.

Methylvinyldimethoxysilane (MVDMS, TCI) and diphenyldiethoxysilane were taken into and mixed in a 100 mL two-neck flask at a molar ratio of 1:1. Subsequently, water and a hydrochloric acid catalyst were added thereto at ratios of 1 mol and 0.0001 mol, respectively, with respect to 1 mol of the mixture and stirred at 60° C. through reflux for 1 hour. Subsequently, 0.03 mol zirconium propoxide was added thereto with respect to 1 mol of the mixture, and then, stirred through reflux for 47 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a vinyl-silicon bond was finally obtained.

Based on the mixture of the oligosiloxane resin having the hydrogen-silicon bond and the oligosiloxane resin having the vinyl-silicon bond, a 20 ppm platinum catalyst was added to 100 parts by weight of the oligosiloxane mixture. After the oligosiloxane resin mixture, to which the platinum catalyst was added, was sufficiently stirred, it was cured at 150° C. for 2 hours by carrying out defoaming.

### Example 4

Triethoxysilane and dimethyldiethoxysilane were taken into and mixed in a 100 mL two-neck flask at a molar ratio of 1:1. Subsequently, water and a hydrochloric acid catalyst were added thereto at ratios of 1.5 mol and 0.0001 mol, respectively, with respect to 1 mol of the mixture and stirred at 60° C. through reflux for 48 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a hydrogen-silicon bond was finally obtained.

Vinyltriethoxysilane (VTES, TCI) and dimethyldiethoxysilane (DPDES, Aldrich) were taken into and mixed in a 100 mL two-neck flask at a molar ratio of 1:1. Subsequently, water and a hydrochloric acid catalyst were added thereto at ratios of 1 mol and 0.0001 mol, respectively, with respect to 1 mol of the mixture and stirred at 60° C. through reflux for 1 hour. Subsequently, 0.03 mol zirconium propoxide was added thereto with respect to 1 mol of the mixture, and then, stirred through reflux for 47 hours. Subsequently, the mixture was further stirred under a nitrogen purge for 12 hours. After the resin obtained from the reaction was subject to vaporization of unreacted methanol using a depressurization vaporizer at −0.1 MPa and 60° C. for 30 minutes, and filtered by using a 0.45 μm Teflon filter, an oligosiloxane resin having a vinyl-silicon bond was finally obtained.

Based on the mixture of the oligosiloxane resin having the hydrogen-silicon bond and the oligosiloxane resin having the vinyl-silicon bond, a 20 ppm platinum catalyst was added to 100 parts by weight of the oligosiloxane mixture. After the oligosiloxane resin mixture, to which the platinum catalyst was added, was sufficiently stirred, it was cured at 150° C. for 2 hours by carrying out defoaming.

### Comparative Example

A transparent siloxane material generally used for silicon LED encapsulating was cured at 150° C. for 2 hours by performed with stirring and defoaming as in the Examples.

### Experimental Example

The physical properties of the samples obtained in Examples 1 to 4 and the Comparative Example above were evaluated by using the method described hereinafter, and the following Table 1 provides the results. After ²⁹Si NMR spectra were measured by using a nuclear magnetic resonance spectrometer (Bruker Biospin DMX600), a degree of condensation was calculated by using the measurement. A refractive index (@633 nm) was measured by mixing the organic oligosiloxane resins including the vinyl-silicon bond and the hydrogen-silicon bond, respectively, with each other and thermally curing the mixture in the presence of a platinum catalyst. For a heat resistance test, reduction of transmittance of the cured material was identified in a 180° C. oven for 1,000 hours. For an ultraviolet resistance test, reduction of transmittance of the cured material was identified in a UVB (300 nm) ultraviolet environment for 1,000 hours. The transmittance was measured by using UV-3101PC, which is the UV/VIS/NIR spectrum analyzer of Shimadzu Corporation.

The following Table 1 shows a degree of concentration of the oligosiloxane resin having the hydrogen-silicon bond or the vinyl-silicon bond and a refractive index of the siloxane cured material in accordance with the Examples.

TABLE 1

| | Example | Example | Example | Example | Comparative |
|---|---|---|---|---|---|
| | 1 | 2 | 3 | 4 | Example |
| Degree of | 96 | 93 | 98 | 99 | |
| Condensation (%) | | | | | |
| Hardness (Shore D) | 26 | 75 | 65 | 24 | 41 |
| Refractive Index | 1.43 | 1.53 | 1.57 | 1.45 | 1.42 |
| Heat Resistance | 1 | 2 | 2 | 1 | 7 |
| (Transmittance | | | | | |
| Variation %) | | | | | |
| Ultraviolet | 4 | 12 | 10 | 3 | 20 |
| Resistance | | | | | |
| (Transmittance | | | | | |
| Variation %) | | | | | |

Examples 3 and 4 relate to the case where metal alkoxide was added to the siloxane resin, and it was identified that Example 3 improved the degree of condensation and the refractive index, compared to Example 2, and Example 4 improved the degree of condensation and the refractive index, compared to Example 1. It was also identified that the refractive index is significantly improved, compared to a commercial low refractive index siloxane packing material. From the results of the Examples, it was identified that the oligosiloxane resin in accordance with the example embodiments exhibited a high degree of the condensation, and the cured material prepared based on the oligosiloxane resin exhibited a high refractive index, heat resistance, and ultraviolet resistance and is ideal for application to an optical siloxane cured material. Simultaneously with the high refractive index, the high degree of condensation resulting from the hydrolysis-condensation reaction, and the increase of the heat resistance and the ultraviolet resistance resulting from increase of siloxane bonds and increase of crosslink density were identified.

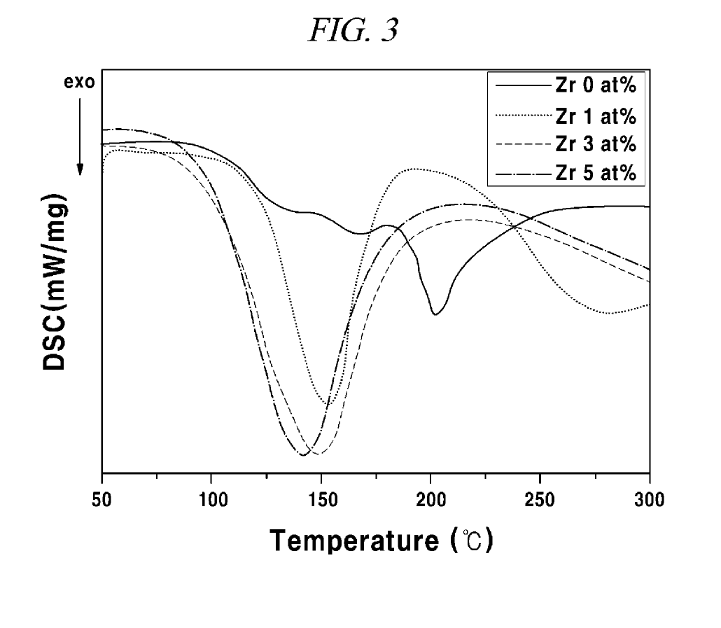

FIG. 3 is a differential scanning calorimetry (DSC) graph according to increase of an amount of zirconium propoxide to be added with respect to Example 2, which was measured by using Netzsch, DSC 200 F3 Maia. As a result of the DSC measurement, it was identified that as the amount of the metal alkoxide to be added increases, the temperature, at which the curing in preparing the transparent cured siloxane material starts, was lowered, and the curing reactivity was significantly improved. In FIG. 3, the black line shows a graph corresponding to Example 2, and the blue line shows a graph corresponding to Example 3. From the results of the Examples, it was identified that the curing temperature was lowered, and the curing reactivity was improved when metal alkoxide was added in synthesizing the oligosiloxane resin in accordance with the example embodiments, compared to when no metal alkoxide was added. From the results, it was identified that there was a catalytic effect in promoting the curing when the metal alkoxide was added.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A preparing method of a transparent cured siloxane material, comprising:
(a) being reacted by hydrolysis-condensation reaction of a reactant including an alkoxysilane selected from the group consisting of the following Chemical Formulas 1, 2, 3, and combinations thereof to prepare an oligosiloxane resin having a vinyl-silicon bond: 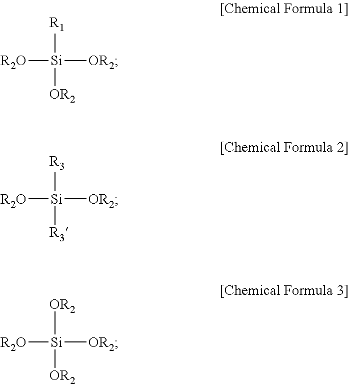
wherein the formulas,
each of R₁, R₃, and R₃′ is independently a vinyl group, a methyl group or a phenyl group, and
R₂ is a linear or branched C₁ to C₇ alkyl group,
provided that the alkoxysilane included in the reactant has at least one vinyl-silicon bond and that the case where the reactant including the alkoxysilane includes only the alkoxysilane of Chemical Formula 3 is excluded;
(b) being reacted by hydrolysis-condensation reaction of a reactant including an alkoxysilane selected from the group consisting of the following Chemical Formulas 4, 5, 6, and combinations thereof to prepare an oligosiloxane resin having a hydrogen-silicon bond: 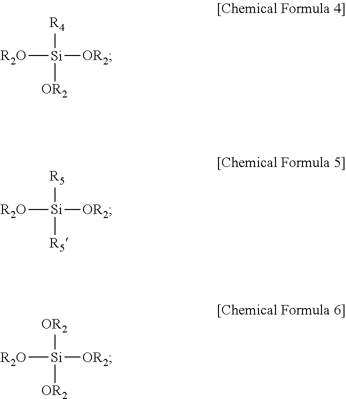
wherein the formulas,
each of R₄, R₅, and R₅′ is independently hydrogen, a methyl group or a phenyl group, and
R₂ is a linear or branched C₁ to C₇ alkyl group,
provided that the alkoxysilane included in the reactant has at least one hydrogen-silicon bond and that the case where the reactant including the alkoxysilane includes only the alkoxysilane of Chemical Formula 6 is excluded; and
(c) adding a metal catalyst for hydrosilylation to a mixture including the prepared oligosiloxane resin having the vinyl-silicon bond and the prepared oligosiloxane resin having the hydrogen-silicon bond to cure the mixture.

2. The preparing method of claim 1,
wherein the alkoxysilane includes a member selected from the group consisting of vinyltrimethoxysilane, vinyltriethoxysilane, vinyltripropoxysilane, methylvinyldimethoxysilane, methylvinyldiethoxysilane, methylvinyldipropoxysilane, dimethyldimethoxysilane, dimethyldiethoxysilane, diphenyldimethoxysilane, diphenyldiethoxysilane, methyldimethoxysilane, methyldiethoxysilane, methyltrimethoxysilane, methyltriethoxysilane, tetramethylorthosilicate, tetraethylorthosilicate and combinations thereof.

3. The preparing method of claim 1,
wherein a metal alkoxide is further added to each of the reactant including the alkoxysilane in the steps (a) and/or (b).

4. The preparing method of claim 3,
wherein the metal alkoxide acts as a catalyst to promote curing in the step (c).

5. The preparing method of claim 3,
wherein the metal alkoxide includes a member selected from the group consisting of zirconiumpropoxide, zirconiumethoxide, zirconiumbutoxide, titaniumpropoxide, titaniumethoxide, germaniumethoxide, aluminumethoxide, aluminumtributoxide, aluminumpropoxide, tantalumethoxide, tintetrapropoxide, and combinations thereof.

6. The preparing method of claim 1,
wherein the hydrolysis-condensation reaction of the reactant including the alkoxysilane is performed in the presence of an acidic or basic catalyst.

7. The preparing method of claim 6,
wherein an amount of the acidic or basic catalyst is from about 0.0001 mol to about 1 mol with respect to 1 mole of the alkoxysilane.

8. The preparing method of claim 6,
wherein the acidic catalyst includes a member selected from the group consisting of an acidic ion exchange resin, a hydrochloric acid, a sulfuric acid, a nitric acid, a phosphoric acid, a chlorosulfonic acid, an iodic acid, a tartaric acid, a perchloric acid, a polyphosphoric acid, a pyrophosphoric acid, a para-toluic acid, a trichloroacetic acid, a formic acid, an acetic acid, a citric acid, and combinations thereof.

9. The preparing method of claim 6,
wherein the basic catalyst includes a member selected from the group consisting of sodium hydroxide, potassium hydroxide, ammonia, n-butylamine, di-n-butylamine, tri-n-butylamine, imidazole, ammonium perchlorate, barium hydroxide, and combinations thereof.

10. The preparing method of claim 1,
wherein the metal catalyst comprises a member selected from the group consisting of platinum, rhodium, iridium, palladium, ruthenium, and combinations thereof.

11. The preparing method of claim 1,
wherein the curing in the step (c) includes a heat treatment performed at a temperature of about 100° C. or higher.

12. A transparent cured siloxane material, comprising:
an oligosiloxane resin having a vinyl-silicon bond from about 10 parts by weight to about 90 parts by weight, which is prepared by being reacted by hydrolysis-condensation reaction of a reactant including an alkoxysilane selected from the group consisting of the following Chemical Formulas 1, 2, 3, and combinations thereof: 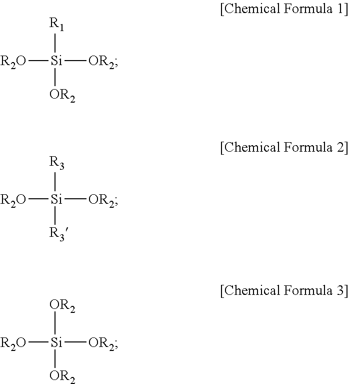
wherein the formulas,
each of R₁, R₃, and R₃′ is independently a vinyl group, a methyl group or a phenyl group, and
R₂ is a linear or branched C₁ to C₇ alkyl group,
provided that the alkoxysilane included in the reactant has at least one vinyl-silicon bond and that the case where the reactant including the alkoxysilane includes only the alkoxysilane of Chemical Formula 3 is excluded;
about 9 parts by weight to about 90 parts by weight of an oligosiloxane resin having a hydrogen-silicon bond, which is prepared by being reacted by hydrolysis-condensation reaction of a reactant including an alkoxysilane selected from the group consisting of the following Chemical Formulas 4, 5, 6, and combinations thereof: 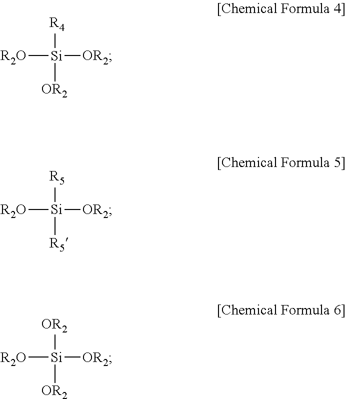
wherein the formulas,
each of R₄, R₅, and R₅′ is independently hydrogen, a methyl group or a phenyl group, and
R₂ is a linear or branched C₁ to C₇ alkyl group,
provided that the alkoxysilane included in the reactant has at least one hydrogen-silicon bond and that the case where the reactant including the alkoxysilane includes only the alkoxysilane of Chemical Formula 6 is excluded; and
about 0.01 parts by weight to about 1 part by weight of a metal catalyst for hydrosilylation.

13. The transparent cured siloxane material of claim 12,
wherein the cured material the transparent siloxane is used as a light emitting diode encapsulating material or an optical material.

14. The transparent cured siloxane material of claim 12, further comprising:
an additive selected from the group consisting of a solvent, a dye, a pigment, a flavoring, a surfactant, an antioxidant, a nano-particle of oxide or nitride, an anti-flaming agent, a metal filler, an adhesion promoter, a corrosion inhibitor, a light stabilizer, a heat stabilizer, a dispersant, a sterilizer, a heat-resisting agent, and combinations thereof.

15. A light emitting diode encapsulating material, comprising the transparent cured siloxane material according to claim 12.

16. A light emitting diode capsulated by using the light emitting diode encapsulating material according to claim 15.
